(19) United States
(12) Patent Application Publication
(10) Pub. No.: US 2012/0194306 A1
(43) Pub. Date: Aug. 2, 2012

(54) PREVENTING CONTACT STICTION IN MICRO RELAYS

(75) Inventors: Uppili Sridhar, Plano, TX (US); Quanbo Zou, Plano, TX (US); Amit S. Kelkar, Flower Mound, TX (US); Xuejun Ying, San Jose, CA (US)

(73) Assignee: Maxim Integrated Products, Inc., Sunnyvale, CA (US)

(21) Appl. No.: 13/018,499

(22) Filed: Feb. 1, 2011

(51) Int. Cl. H01H 1/0237

(52) U.S. Cl. 335/196

(57) ABSTRACT

A micro relay of a micro-electro-mechanical system (MEMS), includes a cap substrate, a first electrical contact, an actuator, and a second electrical contact. The first electrical contact is formed on the cap substrate, includes a platinum group metal, and includes a first surface layer of an oxide of the platinum group metal. The second electrical contact is formed on the actuator, includes the platinum group metal, and includes a second surface layer of the oxide of the platinum group metal. At least a first portion of the first surface layer contacts at least a second portion of the second surface layer during cycling of the micro relay.

### FIELD

The present application is related to micro-electro-mechanical systems (MEMS) and more particularly to micro relays.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A micro-electro-mechanical system (MEMS) may include various mechanical, electrical, and/or electro-mechanical components. For example only, MEMS may include a processor, a micro sensor, a micro actuator, and/or one or more other components. One type of micro actuator is a micro relay.

A micro relay typically includes a top cap, a bottom cap, an actuator, and two or more contacts. The actuator is disposed within a cavity between the top and bottom caps. The actuator is movable within the cavity to make and break electrical contact between two or more of the contacts.

Micro relays may be used in various technology areas, such as automated testing equipment (ATE) systems, radio frequency (RF) antenna switching, handheld devices, and other devices. Some ATE systems include pin electronics that allow connection/disconnection to a device under test. For example only, a micro relay may connect/disconnect the device under test.

### SUMMARY

A micro relay of a micro-electro-mechanical system (MEMS), includes a cap substrate, a first electrical contact, an actuator, and a second electrical contact. The first electrical contact is formed on the cap substrate, includes a platinum group metal, and includes a first surface layer of an oxide of the platinum group metal. The second electrical contact is formed on the actuator, includes the platinum group metal, and includes a second surface layer of the oxide of the platinum group metal. At least a first portion of the first surface layer contacts at least a second portion of the second surface layer during cycling of the micro relay.

In other features, the platinum group metal is Ruthenium.

In still other features, the platinum group metal is Rhodium.

In further features, the first and second electrical contacts are formed by one of deposition and plating.

In still further features, the first and second electrical contacts are formed by sputtering.

In other features, the first and second surface layers are formed by annealing the first and second electrical contacts.

In still other features, the first and second surface layers are formed by subjecting the micro relay to approximately a predetermined temperature for a predetermined period while providing an oxidant to the micro relay.

In further features, the oxidant is one of diatomic oxygen and ozone.

In still further features, the predetermined temperature is between 200 degrees Celsius and 450 degrees Celsius, inclusive, and the predetermined period is between 30 minutes and 60 minutes, inclusive.

In other features, a depth of the first and second surface layers is between 20 Angstroms and 450 Angstroms, inclusive.

A method of manufacturing a micro relay of a micro-electro-mechanical system (MEMS), includes: forming a first electrical contact of a platinum group metal on a cap substrate of the micro relay; forming a second electrical contact of the platinum group metal on an actuator of the micro relay; and oxidizing first and second surface layers of the first and second electrical contacts, respectively. At least a first portion of the first surface layer contacts at least a second portion of the second surface layer during cycling of the micro relay.

In other features, the platinum group metal is Ruthenium.

In still other features, the platinum group metal is Rhodium.

In further features, the method further includes forming the first and second electrical contacts by one of deposition and plating.

In still further features, the method further includes forming the first and second electrical contacts by sputtering.

In other features, the method further includes forming the first and second surface layers by annealing the first and second electrical contacts.

In still other features, the method further includes subjecting the micro relay to approximately a predetermined temperature for a predetermined period while providing an oxidant to the micro relay.

In further features, the oxidant is one of diatomic oxygen and ozone.

In still further features, the predetermined temperature is between 200 degrees Celsius and 450 degrees Celsius, inclusive, and the predetermined period is between 30 minutes and 60 minutes, inclusive.

In other features, a depth of the first and second surface layers is between 20 Angstroms and 450 Angstroms, inclusive.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross-sectional view of a first example of a micro relay in an open state according to the present disclosure;

FIG. 2 is a cross-sectional view of a second example of a micro relay in an open state according to the present disclosure;

FIG. 3 is cross-sectional view of the first example of the micro relay in a closed state according to the present disclosure;

FIG. 4 is a cross-sectional view of the second example of the micro relay in a closed state according to the present disclosure;

FIG. 5 is an example magnified image of a surface of a hard metal contact of a micro relay with damage attributable to contact stiction;

FIG. 6 is a cross-sectional view of a third example of a micro relay in an open state according to the present disclosure;

FIG. 7 is a cross-sectional view of a fourth example of a micro relay in an open state according to the present disclosure;

FIG. 8 is a cross-sectional view of the third example of the micro relay in the closed state according to the present disclosure;

FIG. 9 is a cross-sectional view of the fourth example of the micro relay in the closed state according to the present disclosure;

FIG. 10 is a functional block diagram of an example hard metal contact oxidation system according to the present disclosure;

FIG. 11 is an example magnified image of a surface of a hard metal contact of a micro relay that has been oxidized;

FIG. 12 is an example flowchart depicting a method of producing a micro relay having hard metal contacts with oxidized surface layers according to the present disclosure; and

FIG. 13 is an example Weibull plot of a percentage of failed micro relays as a function of a number of cycles for micro relays having hard metal contacts with and without oxidized surface layers.

### DETAILED DESCRIPTION

The following description is merely illustrative in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

A micro relay of a micro-electro-mechanical system (MEMS) includes contacts made of a hard metal or a mixture of hard metal and one or more other metals. For example only, the hard metal may include Ruthenium (Ru), Rhodium (Rh), and/or another suitable platinum group metal. The hard metal is hard relative to other soft metals that electrical contacts may be made of, such as gold, indium, etc.

The contacts may be formed, for example, using a thin film deposition process, such as sputtering. During formation, the hard metal may absorb contaminants. The contaminants can polymerize during cycling of the micro relay. The polymers may cause the contacts to stick (in a closed state) when the contacts should be in an open state. A condition when the contacts stick together (and create a short across the contacts) is referred to herein as stiction. Over time, stiction may cause portions of one contact to fracture and stick to the other contact.

The contacts of a micro relay are treated according to the present disclosure to oxidize surface layers of the contacts. The oxidation of the contacts tends to significantly reduce or eliminate contaminants that may be present on or near the surfaces of the contacts and may significantly reduce or prevent other contaminants from being absorbed during cycling. The ductility of the oxide is also less than the ductility of the hard metal. Therefore, hard metal contacts with oxidized surface layers are less likely to sustain ductile fractures than hard metal contacts without oxidized surface layers. Over a lifetime, micro relays having hard metal contacts with oxidized surface layers tend to exhibit stiction less frequently than micro relays having hard metal contacts without oxidized surface layers.

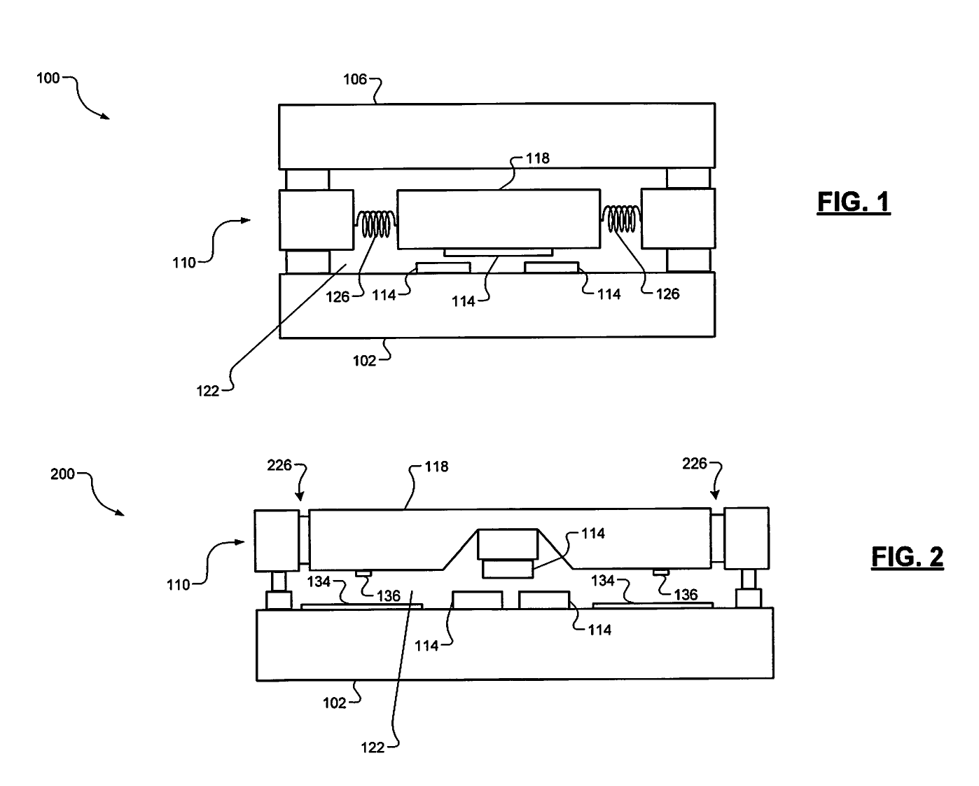

Referring now to FIG. 1, a cross-sectional view of an example of a MEMS micro relay 100 is presented. The micro relay 100 includes a bottom cap substrate 102, a top cap substrate 106, and an electrically conductive actuator layer 110. For example only, the bottom cap substrate 102 and/or the top cap substrate 106 can include a silicon cap, a ceramic cap, and/or a glass cap. The micro relay 100 also includes two or more contacts 114. For example only, the micro relay 100 includes three contacts 114 in the example of FIG. 1.

One or more of the contacts 114 may be implemented on a surface of the bottom cap substrate 102 facing the actuator layer 110. For example only, two of the contacts 114 are implemented on the bottom cap substrate 102 in the example of FIG. 1. One or more of the contacts 114 may be implemented on a surface of the actuator layer 110 facing the bottom cap substrate 102. For example only, one of the contacts 114 is implemented on the actuator layer 110 in the example of FIG. 1. One or more electrically conductive vias (not shown) may be formed, for example, through the bottom cap substrate 102 to enable electrical connection to the contacts 114. One or more electrically conductive vias may additionally or alternatively be formed through to the top cap substrate 106 in various implementations.

The actuator layer 110 includes an actuator region 118 that is supported within a cavity 122 between the bottom and top cap substrates 102 and 106. One or more flexible members 126 may support the actuator region 118 within the cavity 122. For example only, the flexible members 126 may include micro springs or another suitable member having suitable flexibility and resiliency.

Referring now to FIG. 2, another cross-sectional view of an example micro relay 200 is presented without a top cap substrate. In various implementations, such as in the example of FIG. 2, one or more flexible regions 226 of the actuator layer 110 may additionally or alternatively support the actuator region 118 within the cavity 122. For example only, the flexible regions 226 may be portions of the actuator layer 110 where one or more regions of the actuator layer 110 have been removed or thinned. Portions of the actuator layer 110 may be removed or thinned to form the flexible regions 226 using etching or another suitable process. The flexible members 126 and the flexible regions 226 will be collectively referred to hereafter as the flexible members 126. A micro relay may also include one or more dielectric regions and/or one or more bumpers. For example only, the micro relay 200 includes dielectric regions 234 and bumpers 236 in the example of FIG. 2.

Referring to FIGS. 1 and 2, the flexible members 126 enable the contact 114 implemented on the actuator region 118 to be drawn into electrical contact with the contacts 114 implemented on the bottom cap substrate 102. The micro relay 100 is in an open state when the contact 114 implemented on the actuator region 118 is not in electrical communication with the contacts 114 implemented on the bottom cap substrate 102. The micro relays 100 and 200 are in open states in the examples of FIGS. 1 and 2, respectively.

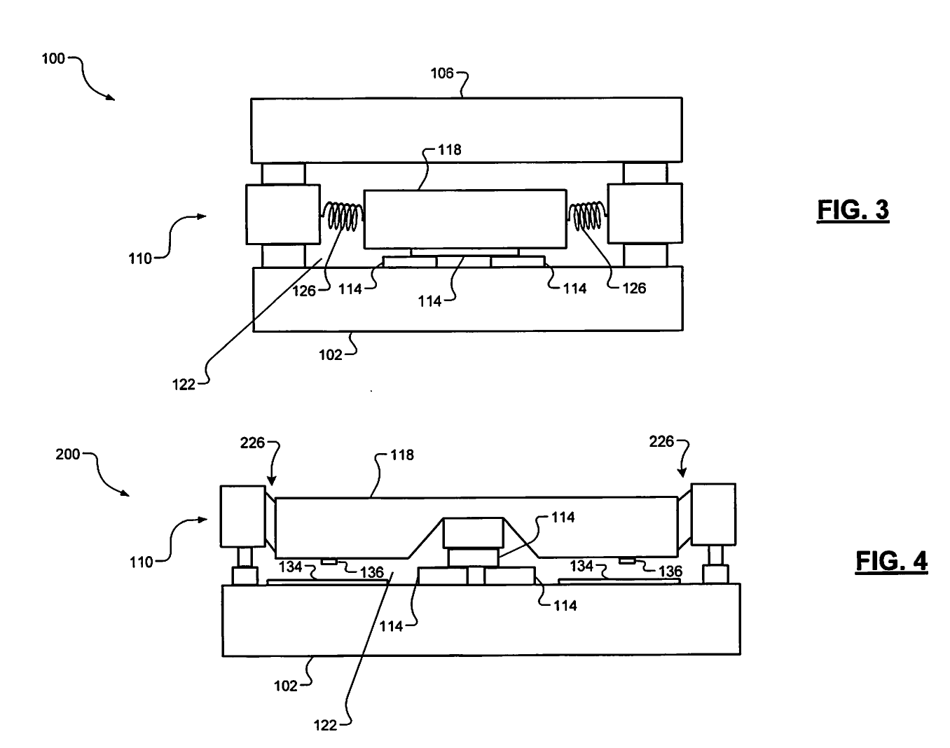

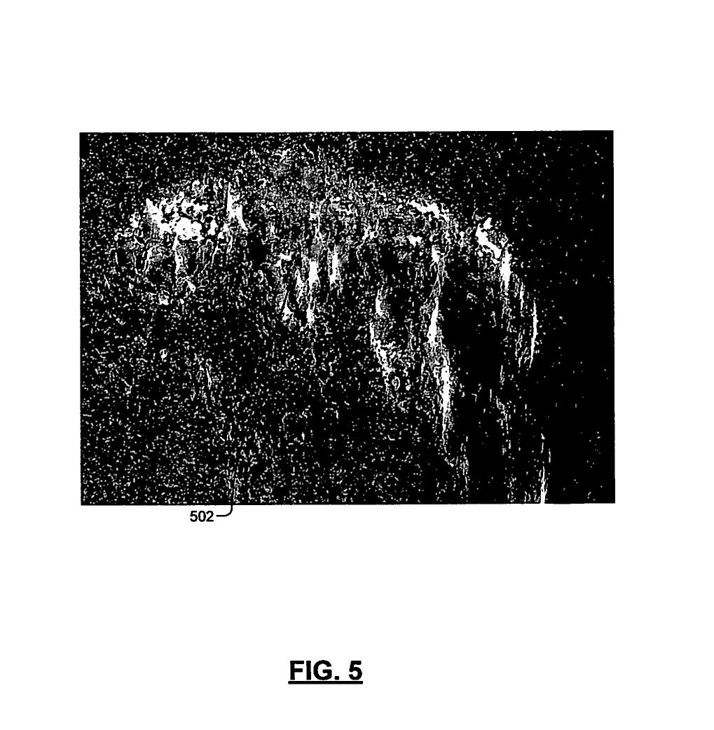

The micro relay 100 is in a closed state when the contact 114 implemented on the actuator region 118 is in electrical contact with the contacts 114 implemented on the bottom cap substrate 102. FIGS. 3 and 4 include example diagrams of the micro relays 100 and 200, respectively, being in closed states.

The flexible members 126 also apply a force to the actuator region 118 to restore the micro relay 100 to the open state. Relative to other types of relays (e.g., Reed relays), the restoring force of micro relays may be small. While the two example micro relays 100 and 200 are shown and discussed, a micro relay may include another suitable type of structure, such as a cantilever type structure.

The contacts 114 are each made of one or more types of hard metal, such as Ruthenium (Ru), Rhodium (Rh), and/or another suitable platinum group metal. Hard metals are defined by their greater hardness relative to soft metals that may be used in electrical contacts, such as gold, silver, indium, and other types of soft metals. The contacts 114 may also include one or more types of metals.

The contacts 114 may be formed, for example, using deposition, plating, or another suitable process. For example only, the contacts 114 may be formed via sputtering, which is a type of thin film deposition. The contacts 114 may be formed before or after the actuator layer 110 is bonded to the bottom and/or top cap substrates 102 and 106, respectively.

For example only, after the contacts 114 have been formed on the actuator layer 110 and the bottom cap substrate 102, the actuator layer 110 may be bonded to the bottom cap substrate 102 or to the top cap substrate 106. The actuator layer 110 may later be bonded to the other one of the bottom cap substrate 102 and the top cap substrate 106 to hermetically seal the micro relay 100. For example only, the bonding may be anodic bonding, hermetic bonding, or another suitable type of bonding. The micro relay 100 is hermetically sealed after the contacts 114 are formed.

During formation of the contacts 114, the hard metal may absorb contaminants. Contaminant absorption may be attributable to chemical activity of the hard metal during contact formation. Contaminants still present after the micro relay 100 is hermetically sealed may form frictional polymers on the contacts 114 during cycling between the open state and the closed state. For example only, contaminants may polymerize during cycling.

A majority of the contaminant absorption may be concentrated near and on surfaces of the contacts 114, where the contacts 114 may touch. The contaminants (or the frictional polymers formed from the contaminants) may cause the contacts 114 to stick together after a period of being in the closed state. In other words, the contaminants may cause a micro relay to remain in the closed state at times when the micro relay should be in the open state.

The condition of the contacts 114 remaining stuck together will be hereafter referred to as contact stiction. Over time, contact stiction may cause portions of one of the contacts 114 to fracture and stick to another one of the contacts 114. A portion of the one of the contacts 114 sticking to another one of the contacts 114 may cause additional fractures to occur.

Referring now to FIG. 5, an example illustration of a portion of a surface of a contact of a micro relay is presented. The micro relay of the example of FIG. 5 has been subjected to one-hundred million cycles. Contact stiction may cause the surface of the contact to sustain ductile fractures, such as ductile fracture 502. The fractured part of the contact may remain stuck to another contact (not shown) after the fracture occurs.

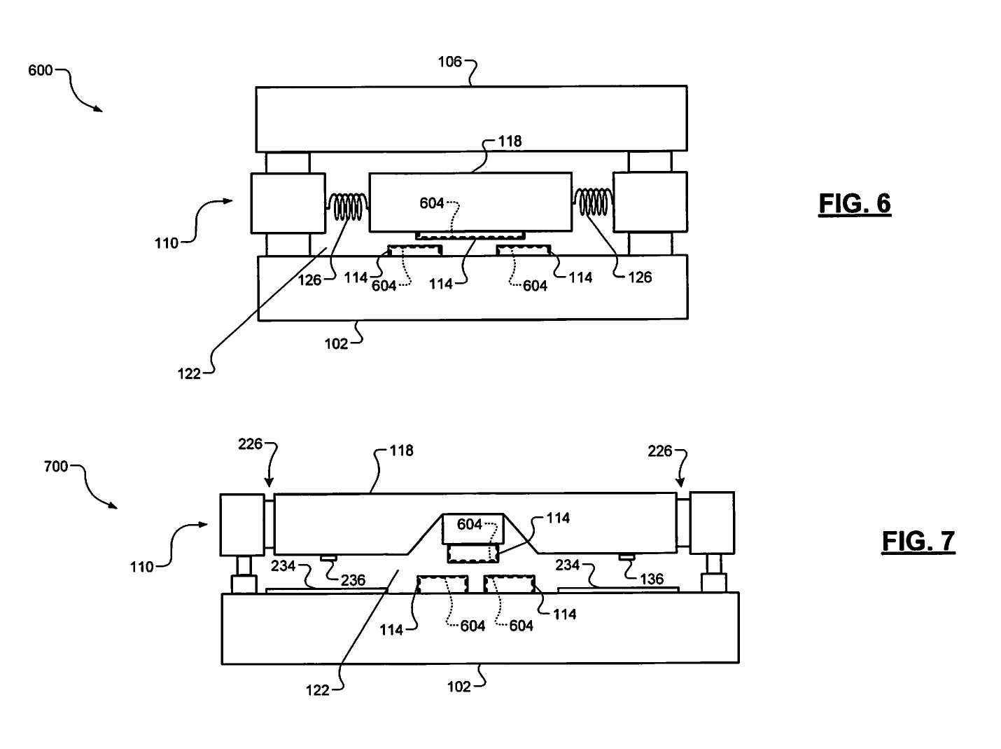

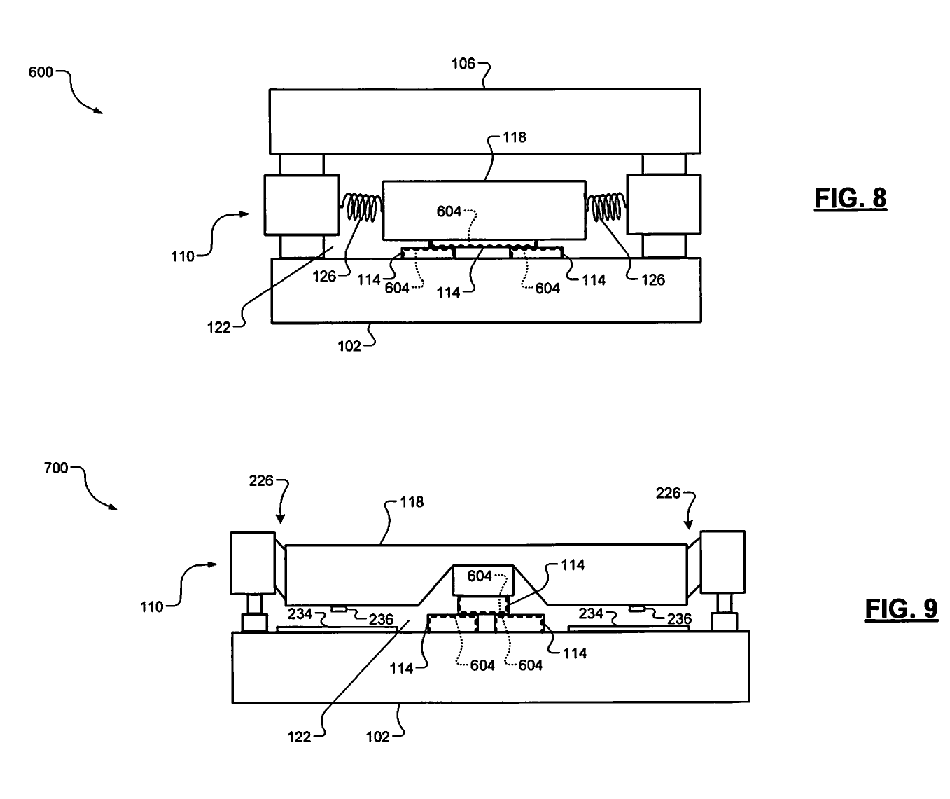

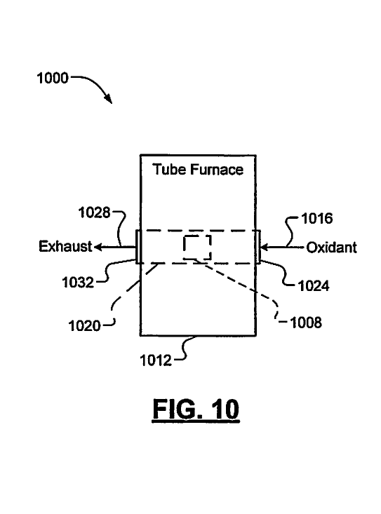

Referring now to FIG. 6, a cross-sectional view of an example MEMS micro relay 600 in an open state is presented. FIG. 7 is a cross-sectional view of an example MEMS micro relay 700 in an open state. FIGS. 8 and 9 are cross-sectional views of the micro relays 600 and 700 in closed states, respectively.

After formation of the contacts 114, surfaces of the contacts 114 of the micro relay are oxidized according to the present disclosure such that the contacts 114 include surface layers 604 of an oxide of the hard metal. In the case of the hard metal being Ruthenium, for example, the oxide may be Ruthenium tri-oxide (Ru₂O₃) or another suitable oxide of Ruthenium.

Referring now to FIG. 10 is a functional block diagram of an example hard metal contact oxidation system 1000. With continuing reference to FIGS. 6-9, the oxidized surface layers 604 may be created via annealing. For example only, a micro relay 1008 with hard metal contacts may be annealed to form the oxidized surface layers 604 on the hard metal contacts using a tube furnace 1012 and an oxidant 1016. While the micro relay 1008 is shown and described as being an individual micro relay, the micro relay 1008 may represent a plurality of micro relays which can be diced into individual micro relays.

The tube furnace 1012 includes a tube 1020 within which the micro relay 1008 is positioned. The tube furnace 1012 maintains temperature within the tube 1020 at approximately a predetermined temperature. The oxidant 1016 is input to the tube 1020 via an inlet 1024. Exhaust 1028 may exit the tube 1020 via an outlet 1032.

The annealing is performed at the predetermined temperature. For example only, the predetermined temperature may be between approximately 200° Celsius (C.) and approximately 450° C., inclusive. The oxidant 1016 may be input to the tube 1020 and the annealing may be performed for a predetermined period. For example only, the predetermined period may be between approximately 30 minutes and approximately 60 minutes, inclusive. The oxidant 1016 may be, for example, (diatomic) oxygen (O₂), ozone (trioxygen or O₃), air, or another suitable oxidant. The predetermined temperature and the predetermined period may be selected based on a desired depth of the oxidized surface layer 604.

The desired depth of the oxidized surface layer 604 relative to the outer surfaces of the contacts 114 may be between a predetermined minimum depth and a predetermined maximum depth, inclusive. The predetermined minimum depth is greater than zero and less than the predetermined maximum depth. The predetermined minimum depth may be selected based on a depth greater than which contact stiction attributable to contaminant absorption should not occur over an expected lifetime of the micro relay 1008. For example only, the predetermined minimum depth may be approximately 20 Angstroms where the hard metal is Ruthenium.

The predetermined maximum depth may be based on a maximum allowable annealing time, one or more maximum allowable resistances of a contact, and/or one or more other suitable factors. For example only, the predetermined maximum depth may be approximately 450 Angstroms. The creation of the oxidized surface layer 604 of the oxide of the hard metal may eliminate all or a majority of contaminants absorbed by the contacts 114 during formation, thereby minimizing the likelihood of contact stiction occurring during cycling.

Metallurgy of the contacts 114 is generally selected to enable a maximum number of cycles to be performed while the electrical resistance of the contacts 114 remains less than the maximum allowable resistances. For example only, the maximum allowable resistances may be approximately 2 ohms when the micro relay is in the closed state and approximately 100 ohms when the micro relay is in the open state. With the oxidized surface layer 604, the resistance of the contacts 114 generally does not appreciably increase relative to contacts not having the oxidized surface layer 604. For example only, the contacts 114 may have a resistance of approximately 0.25 ohms before oxidation and a resistance of approximately 0.4 ohms after oxidation.

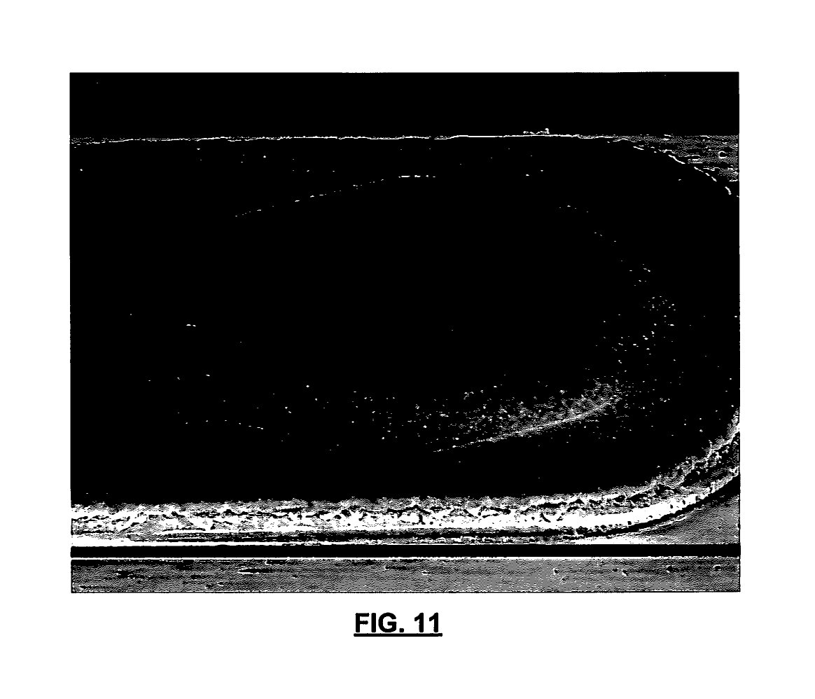

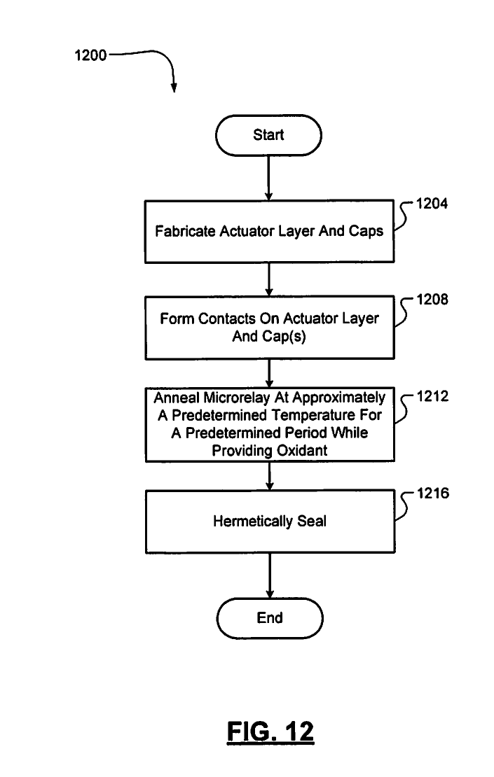

Referring now to FIG. 11, an example illustration of a portion of the oxidized surface layer 604 of a contact of a micro relay is presented. The micro relay of the example of FIG. 11 has been subjected to one-hundred million cycles like the micro relay of the example of FIG. 5. Unlike the micro relay of the example of FIG. 5, however, the contact of the micro relay of FIG. 11 has not sustained damage attributable to contact stiction.

Referring now to FIG. 12, a flowchart depicting an example method 1200 of manufacturing a micro relay having hard metal contacts with oxidized surface layers is presented. Top and bottom caps and an actuator layer of the micro relay are fabricated at 1204. The contacts are formed on the actuator layer and at least one of the top and bottom caps at 1208. The contacts 114 include of a hard metal, such as Ruthenium, Rhodium, or another platinum group metal. The contacts 114 may be formed, for example, via a deposition process, such as sputtering.

At 1212, the micro relay is annealed at approximately a predetermined temperature for a predetermined period while the oxidant 1016 is provided. For example only, the micro relay may be annealed using the tube furnace 1012, the predetermined temperature may be between approximately 200° C. and approximately 450° C., inclusive, and the oxidant 1016 may be (diatomic) oxygen (O₂) or ozone (O₃). The micro relay is annealed at approximately the predetermined temperature while the oxidant 1016 is provided. For example only, the predetermined period may be between approximately 30 minutes and approximately 60 minutes, inclusive. Annealing the micro relay at approximately the predetermined temperature for the predetermined period while providing the oxidant 1016 oxidizes the surfaces of the contacts of the micro relay. Oxidizing the surface of the contacts 114 minimizes the likelihood of contact stiction occurring during cycling over the lifetime of the micro relay. The micro relay is hermetically sealed at 1216. For example only, the micro relay may be hermetically sealing using anodic bonding, hermetic bonding, or in another suitable manner.

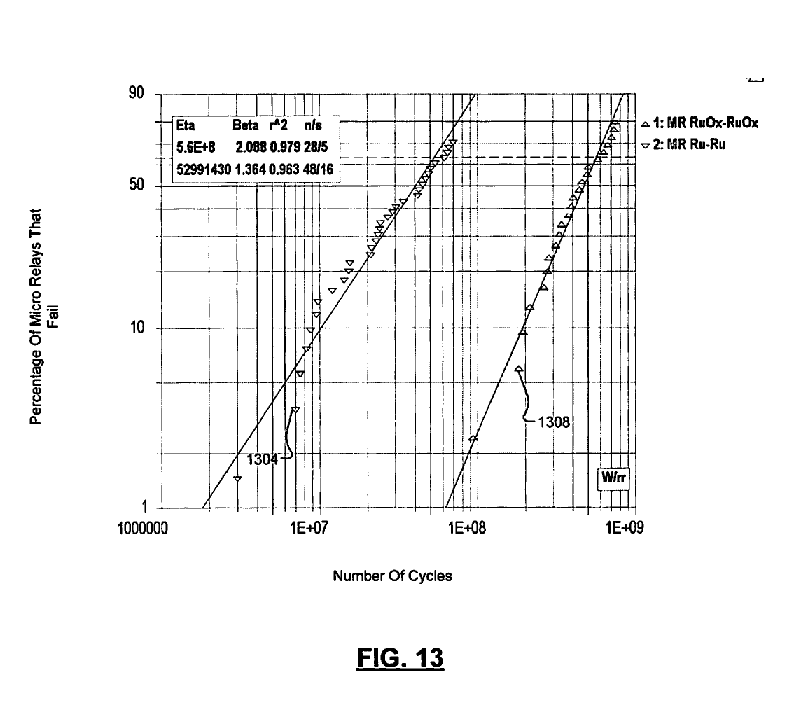

Referring now to FIG. 13, an example Weibull plot of probability of micro relay failure as a function of number of cycles is presented. Each downward pointing triangle, such as downward pointing triangle 1304, may correspond to a percentage of a first sample group of micro relays that satisfy one or more failure criteria after a number of cycles. The micro relays of the first sample group have hard metal contacts without oxidized surface layers. The failure criteria may include, for example, having a contact resistance of greater than a first predetermined contact resistance when in the closed state, having a contact resistance of greater than a second predetermined contact resistance when in the open state, and/or one or more other suitable failure criteria. For example only, the first predetermined contact resistance may be approximately 2 ohms, and the second predetermined contact resistance may be approximately 100 ohms.

Each upward pointing triangle, such as upward pointing triangle 1308, corresponds to a percentage of a second sample group of micro relays that satisfy one or more of the failure criteria after a number of cycles. The micro relays of the second sample group have hard metal contacts with oxidized surface layers. A comparison of the downward facing triangles with the upward facing triangles reveals that the micro relays having hard metal contacts with oxidized surface layers will likely have a longer lifetime. A lifetime may be defined as a maximum number of cycles completed before one or more of the failure criteria are satisfied. A comparison of the downward facing triangles with the upward facing triangles also reveals that the micro relays having hard metal contacts with oxidized surface layers less frequently fail at lower numbers of completed cycles.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A micro relay of a micro-electro-mechanical system (MEMS), comprising:
a cap substrate;
a first electrical contact that is formed on the cap substrate, that includes a platinum group metal, and that includes a first surface layer of an oxide of the platinum group metal;
an actuator; and
a second electrical contact that is formed on the actuator, that includes the platinum group metal, and that includes a second surface layer of the oxide of the platinum group metal,
wherein at least a first portion of the first surface layer contacts at least a second portion of the second surface layer during cycling of the micro relay.

2. The micro relay of claim 1 wherein the platinum group metal is Ruthenium.

3. The micro relay of claim 1 wherein the platinum group metal is Rhodium.

4. The micro relay of claim 1 wherein the first and second electrical contacts are formed by one of deposition and plating.

5. The micro relay of claim 1 wherein the first and second electrical contacts are formed by sputtering.

6. The micro relay of claim 1 wherein the first and second surface layers are formed by annealing the first and second electrical contacts.

7. The micro relay of claim 1 wherein the first and second surface layers are formed by subjecting the micro relay to approximately a predetermined temperature for a predetermined period while providing an oxidant to the micro relay.

8. The micro relay of claim 7 wherein the oxidant is one of diatomic oxygen and ozone.

9. The micro relay of claim 7 wherein the predetermined temperature is between 200 degrees Celsius and 450 degrees Celsius, inclusive, and
wherein the predetermined period is between 30 minutes and 60 minutes, inclusive.

10. The micro relay of claim 1 wherein a depth of the first and second surface layers is between 20 Angstroms and 450 Angstroms, inclusive.

11. A method of manufacturing a micro relay of a micro-electro-mechanical system (MEMS), comprising:
forming a first electrical contact of a platinum group metal on a cap substrate of the micro relay;
forming a second electrical contact of the platinum group metal on an actuator of the micro relay; and
oxidizing first and second surface layers of the first and second electrical contacts, respectively,
wherein at least a first portion of the first surface layer contacts at least a second portion of the second surface layer during cycling of the micro relay.

12. The method of claim 11 wherein the platinum group metal is Ruthenium.

13. The method of claim 11 wherein the platinum group metal is Rhodium.

14. The method of claim 11 further comprising forming the first and second electrical contacts by one of deposition and plating.

15. The method of claim 11 further comprising forming the first and second electrical contacts by sputtering.

16. The method of claim 11 further comprising forming the first and second surface layers by annealing the first and second electrical contacts.

17. The method of claim 11 further comprising subjecting the micro relay to approximately a predetermined temperature for a predetermined period while providing an oxidant to the micro relay.

18. The method of claim 17 wherein the oxidant is one of diatomic oxygen and ozone.

19. The method of claim 17 wherein the predetermined temperature is between 200 degrees Celsius and 450 degrees Celsius, inclusive, and
wherein the predetermined period is between 30 minutes and 60 minutes, inclusive.

20. The method of claim 11 wherein a depth of the first and second surface layers is between 20 Angstroms and 450 Angstroms, inclusive.
